(19) United States
(12) Patent Application Publication
(10) Pub. No.: US 2021/0379665 A1
(43) Pub. Date: Dec. 9, 2021

(54) CALIBRATION UNIT FOR METAL 3D PRINTER, METAL 3D PRINTER, AND BUILT PART MOLDING METHOD

(71) Applicant: MITSUBISHI HEAVY INDUSTRIES, LTD., Tokyo (JP)

(72) Inventors: Shuji TANIGAWA, Tokyo (JP); Yasuyuki FUJIYA, Tokyo (JP); Toshiya WATANABE, Tokyo (JP); Masashi KITAMURA, Tokyo (JP); Shuho TSUBOTA, Tokyo (JP)

(21) Appl. No.: 17/406,707

(22) Filed: Aug. 19, 2021

Related U.S. Application Data
(63) Continuation of application No. PCT/JP2019/038698, filed on Oct. 1, 2019.

(30) Foreign Application Priority Data
Mar. 4, 2019 (JP) 2019-038940

(51) Int. Cl. B22F 10/85; B33Y 10/00; B33Y 30/00; B33Y 50/00; B22F 10/28; B22F 12/90; B23K 26/70; G01J 1/42

(52) U.S. Cl. CPC B22F 10/85; B33Y 10/00; B33Y 30/00; B33Y 50/00; B23K 26/342; B22F 12/90; B23K 26/705; G01J 1/42; B22F 10/28

(57) ABSTRACT

The present invention accurately detects the state of a radiated light beam. According to the present invention, a calibration unit for a metal 3D printer that radiates a light beam at a powder to mold a built part has: a base part that is attached to a stage that is irradiated with the light beam from the metal 3D printer; and a plurality of attachment parts that are provided to the base part at different locations and have detection devices that detect the light beam attached thereto. The attachment parts are provided at different angles such that the detection directions of the detection devices attached thereto are different.

### CROSS-REFERENCE TO RELATED APPLICATION

The application is a continuation of PCT International Application No. PCT/JP2019/038698 filed on Oct. 1, 2019 which claims the benefit of priority from Japanese Patent Application No. 2019-038940 filed on Mar. 4, 2019, the entire contents of which are incorporated herein by reference.

### TECHNICAL FIELD

The present disclosure relates to a calibration unit for a metal 3D printer, a metal 3D printer, and a built part molding method.

### BACKGROUND ART

In recent years, built part molding methods for molding a three-dimensional built part using a powder such as a metal powder as a raw material have been put into practical use. For example, Patent Document 1 describes a three-dimensional built part that is manufactured by irradiating a metal powder layer with a light beam.

### CITATION LIST

### Patent Literature

[PTL 1] Japanese Unexamined Patent Application Publication No. 2018-126985

### SUMMARY OF INVENTION

### Technical Problem

Here, the quality of the three-dimensional built part is significantly affected by the state of the light beam radiated to the powder. Therefore, is the metal 3D printer, it is required to know the state of the light beam radiated to the powder in advance to adjust the characteristics of the light beam to be radiated.

At least one embodiment of the present invention is to solve the above-described problems, and an object of the present invention is to provide a calibration unit for a metal 3D printer, a metal 3D printer, and a built part molding method capable of appropriately detecting the state of a radiated light beam.

### Solution to Problem

In order to solve the above-described problems and achieve the object, a calibration unit for a metal 3D printer according to the present disclosure is a calibration unit for a metal 3D printer that radiates a light beam to a powder to mold a built part, including a base portion that is attached to a stage to which the light beam of the metal 3D printer is radiated; and a plurality of attachment portions that are provided on the base portion, have detection devices for detecting the light beam attached thereto, and are provided at mutually different positions, and the respective attachment portions being provided at mutually different angles such that detection directions of the detection devices to be attached thereto are different from each other.

According to this calibration unit, the light beam can be appropriately detected.

It preferable that each of the attachment portions is provided with an opening, and a central axis of the opening is inclined to face a center side of surface of the base portion. According to this calibration unit, the light beam can be appropriately detected at each position.

It is preferable that each. of the attachment portions is an opening provided on one surface of the base portion, and a bottom surface thereof is inclined toward a center side of a surface of the base portion. According to this calibration unit, the light beam can be appropriately detected at each position.

It is preferable that the respective attachment portions are provided at mutually different angles such that the detection directions of the detection devices to be attached thereto intersect a surface of the base portion and face a center side of the surface of the base portion. According to this calibration unit, the light beam can be appropriately detected at each position.

It is preferable that the respective attachment portions are provided at mutually different angles such that light receiving surfaces of detection elements of the detection device to be attached thereto are orthogonal t.o the light beam. According to this calibration unit, the light beam can be appropriately detected at each position.

It is preferable that each of the attachment portions is provided with an opening, and a central axis of the opening is variable. According to this calibration unit, the versatility of inspection can be increased.

It is preferable to further include a heat absorbing portion that receives a light beam other than that incident on a detection element of the detection device attached to each of the attachment portions in the light beam radiated toward the attachment portion, and absorbs heat from the received light beam. According to this calibration unit, it is possible to prevent other devices and the like from being damaged due to the heat of the light beam while appropriately detecting the light beam.

It is preferable that the heat absorbing portion is provided closer to a side opposite to a side to which the light beam is radiated than the attachment portion. According to this calibration unit, it is possible to prevent other devices and the like from being damaged due to the heat of the light beam while appropriately detecting the light beam.

It is preferable that the heat absorbing portion is connected to the plurality of attachment portions. According to this calibration unit, it is possible to prevent that other devices and the like from being damaged due to the heat of the light beam while appropriately detecting the light beam.

It is preferable that a plurality of the heat absorbing portions are provided corresponding to the respective attachment portions. According to this calibration unit, it is possible to prevent that other devices and the like from being damaged due to the heat of the light beam while appropriately detecting the light beam.

In order to solve the above-described problems and achieve the object, a metal 3D printer according to the present disclosure includes the calibration unit; the stage to which the calibration unit is attached; the detection device that is attached to each of the attachment portions of the calibration unit; an irradiation unit that radiates the light beam; and a powder supply unit that supplies the powder. Since this metal 3D printer has the calibration unit to which the detection device is attached, the light beam can be appropriately detected at each position on the stage.

It is preferable that the detection device has a beam damper portion that is provided closer to a side to Which the light beam is radiated than a detection element, has the light beam radiated toward the detect on device incident thereon, and emits a part of the incident light beam toward the detection element. According to this metal 3D printer, it is possible to prevent the detection element from being damaged by a high-intensity light beam.

It is preferable that the metal 3D printer further includes a control unit that controls molding of the built part, and the control unit includes an irradiation control unit that causes the light beam to be radiated to the detection device attached to the calibration unit in a state in which the calibration unit is attached to the stage; a state detection unit that acquires a detection result of the light beam from the detection device and detects a state of the light beam for each position on the stage on the basis of the acquired detection result of the light beam; a determination unit that determines whether or not the state of the light beam is normal on the basis of the state of the light beam detected by the state detection unit; and a building control unit, that controls the irradiation unit and the powder supply unit to mold the built part in a case where it is determined that the state of the light beam is normal. According to the metal 3D printer, the molding of the built part with the light beam having an abnormal state can be suppressed, and a molding defect of the built part can be suppressed.

It is preferable that the metal 3D printer further includes an output unit that displays a determination result of the state of the light beam by the determination unit. According to the metal 3D printer, a user can be appropriately notified of the determination result.

It is preferable that the output unit displays at least one of a determination result of the state of the light beam for each position on the stage and a determination result of the state of the light beam for each position of a protection unit that covers an emission. port of the irradiation unit. According to the metal 3D printer, it is possible to appropriately notify the user of which position of the stage or the protection unit is abnormal.

In order to solve the above-described problems and. achieve the object, a built part molding method according to the present disclosure is a built part molding method using a metal 3D printer having a calibration unit, a detection device attached to an attachment portion of the calibration unit, an irradiation unit that radiates a light beam, a powder supply unit that supplies a powder, and a stage to which the calibration unit is attached, the calibration unit including a base portion that is attached to a stage to which the light beam of the metal 3D printer is radiated; and a plurality of attachment portions that are provided on the base portion, have detection devices for detecting the light beam attached thereto, and are provided at mutually different positions, and the respective attachment portions being provided at mutually different angles such that detection directions of the detection devices to be attached thereto are different from each other, and the built part molding method including a step of radiating the light beam to each of the detection devices attached to the calibration unit in a state in which the calibration unit is attached to the stage; a step of acquiring a detection result of the light beam from the detection device and detecting a state of the light beam for each position on the stage on the basis of the acquired detection result of the light beam; a step of determining whether or not the state of the light beam is normal on the basis of the state of the light beam detected in the step of detecting the state of the light beam; and a step of controlling the irradiation unit and the powder supply unit to mold a built part in a case where it is determined that the state of the light beam is normal. According to the built part molding method, the molding of the built part with the light beam having an abnormal state can be suppressed, and a molding defect of the built part can be suppressed.

It is preferable that in the step of detecting the state of the light beam, an average output, an intensity distribution, a radiation position, and a scattered light intensity of the light beam are calculated, and in the step of determining whether or not the state of the light beam is normal, it is determined whether or not the state of the light beam is normal on the basis of the average output, the intensity distribution, the radiation position, and the scattered light intensity of the light beam. According to this built part molding method, since an abnormal state can be appropriately detected, a molding defect of the built part can be suppressed.

It is preferable that in the step of determining whether or not the state of the light beam is normal, it is determined whether or not the state of the light beam is normal by comparing the average output, the intensity distribution, the radiation position, and the scattered light intensity of the light beam with reference data. According to this built part molding method, since an abnormal state can be appropriately detected, a molding defect of the built part can be suppressed.

It is preferable that in the step of determining whether or not the state of the light beam is normal, it is determined that the state of the light beam is normal in a case where the average output, the intensity distribution, and the radiation position of the light beam among the average output, the intensity distribution, the radiation position, and the scattered light intensity of the light beam satisfy conditions. According to this built part molding method, since an abnormal state can be appropriately detected, a molding defect of the built part can be suppressed.

It is preferable that the built part molding method further includes a step of notifying that there is an abnormality in the irradiation unit in a case where it is determined that the state of the light beam is not normal. According to the built part molding method, the user can be appropriately notified of the determination result.

### Advantageous Effects of Invention

According to the present invention, the state of the radiated light beam can be appropriately detected.

### BRIEF DESCRIPTION OF DRAWINGS

FIG. 1 is a schematic view of a metal 3D printer according to the present embodiment.

FIG. 2 is a schematic view of the metal 3D printer according to the present embodiment.

FIG. 3 is a top view of a calibration unit according to the present embodiment.

FIG. 4 is a cross-sectional view of the calibration unit according to the present embodiment.

FIG. 5 is a schematic view illustrating a case where a detection device is attached to the calibration unit.

FIG. 6 is a block diagram of a control device according to the present embodiment.

FIG. 7 is a view illustrating an example of an image of a light beam.

FIG. 8 is a view illustrating a display example of determination results.

FIG. 9 is a view illustrating a display example of determination results.

FIG. 10 is a flowchart illustrating a control flow of the control device according to the present embodiment.

FIG. 11 is a flowchart illustrating a flow for determining a state of a light beam.

FIG. 12 is a cross-sectional view illustrating another example of the calibration unit according to the present embodiment.

FIG. 13 is a top view illustrating another example of the calibration unit according to the present embodiment.

FIG. 14 is a top view illustrating another example of the calibration. unit according to the present embodiment.

### DESCRIPTION OF EMBODIMENTS

Preferred embodiments of the present invention will be described in detail below with reference to the accompanying drawings. In addition, the present invention is not limited to the embodiments, and in a case where there are a plurality or embodiments, the present invention also includes a combination of the respective embodiments.

(Overall Configuration of Metal 3D Printer)

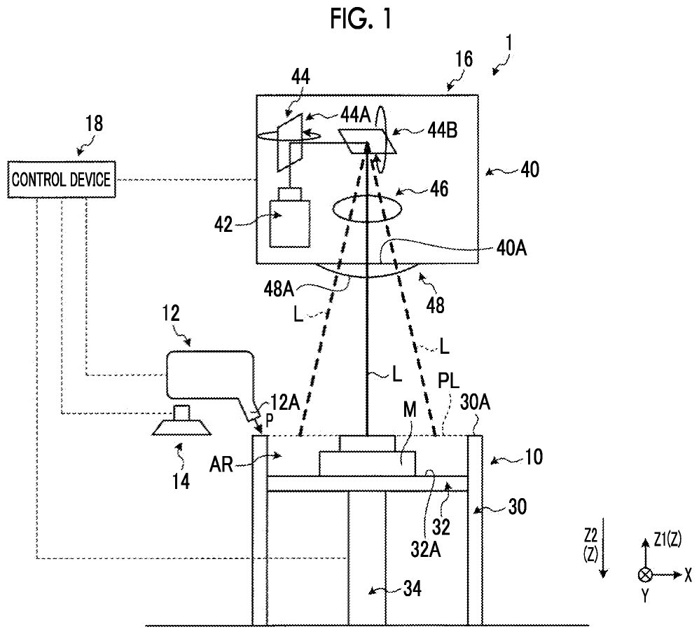

FIG. 1 is a schematic view of a metal 3D printer according to the present embodiment. The metal 3D printer 1 according to the present embodiment molds a built part M, which is a three-dimensional model, from a powder P, using a so-called powder bed method. The powder P is a metal powder in the present embodiment but is not limited to the metal powder, and may be, for example, a resin powder. As illustrated in FIG. 1, the metal 3D printer 1 includes a molding chamber 10, a powder supply unit 12, a blade 14, an irradiation unit 16, and a control device 18. The metal 3D printer 1 supplies the powder P from the powder supply unit 12 onto a stage 32 of the molding chamber 10 under the control of the control device 18, and radiates a light beam L to the powder P supplied onto the stage 32 from the irradiation unit 16 to met solidify or sinter the powder P to mold the built part M. Examples of the built part. M include, but are not limited to, parts such as a gas turbine, a turbocharger, a flying body, and a rocket engine. Hereinafter, one direction along a surface 32A of the stage 32 is referred to as a direction X, and one direction along the surface 32A of the stage 32 and orthogonal to the direction X is referred to as a direction Y. Additionally, a direction orthogonal to the direction X and the direction Y is defined as a direction Z. Additionally, in the direction Z, a direction from the stage 32 toward the irradiation. unit 16 is defined as a direction Z1, and a direction from the irradiation unit 16 toward the stage 32, that is, a direction opposite to the direction Z1, is defined as a direction Z2.

The molding chamber 10 has a housing 30, the stage 32, and a movement mechanism 34. The housing 30 is a housing in which an upper side, that is, a direction Z1 side, is open. The stage 32 is disposed in the housing 30 to be surrounded by the housing 30. The stage 32 is configured to be movable in the direction Z1 and the direction Z2 within the housing 30. A space AR surrounded by the surface 32A of the stage 32 on the direction Z1 side and an inner peripheral surface of the housing 30 is a space to which the powder P is supplied. That is, it can be said that the space AR is a space on the stage 32. The movement mechanism 34 is connected to the stage 32. The movement mechanism 34 moves the stage 32 in the direction Z1 and the direction Z2 under the control of the control device 18.

The powder supply unit 12 is a mechanism that stores the powder P therein. The powder supply unit 12 controls the supply of the powder P via the control device 18, and. supplies the powder P from a supply port 12A to the space AR on the stage 32 under the control of the control device 18. The blade 14 is a squeegeeing blade that horizontally sweeps (squeegees) the powder P supplied to the space AR. The blade 14 is controlled by the control device 18. Here, the plane of the space AR on the direction Z1 side is referred to as a plane Pt. The plane Pt is, for example, a plane along an end surface 30A of the housing 30 on the direction Z1 side. The powder P supplied to the space AR. is swept along the plane Pt by being squeegeed by the blade 14, and the surface of the powder P on the direction Z1 side becomes a powder layer along the plane PL.

In addition, in the present embodiment, the powder P is supplied to the space AR in the direction X by the powder supply unit 12 and the blade 14. That is, a direction to be recoated is the direction X. Additionally, in the present embodiment, an inert gas is supplied to a space between the irradiation unit 16 and the stage 32 with a gas supply unit (not illustrated). In the present embodiment, the gas supply unit supplies the inert gas in the direction Y. That is, a direction in which the inert gas is supplied and a direction in which the inert gas is recoated are different directions, which are the direction X and the direction Y. However, the direction in which the inert gas is supplied and the direction in which the inert gas is recoated are not limited to the direction X. and the direction Y. In addition, the direction in which the inert gas is supplied and the direction in which the inert. gas is recoated preferably intersect each other but may be the same direction.

The irradiation unit 16 is a device that radiates the light beam L onto the stage 32, that is, toward the space AR. The light beam L is a laser beam in the present embodiment but is not limited to the laser beam, and may be, for example, an electron beam. The irradiation unit includes housing 40, a light source unit 42, a scanning unit 44, a lens 46, and a protection unit 46. The housing 40 is a housing that houses the light source unit 42, the scanning unit 44, and the lens 46 inside. The light source unit 42 is an irradiation source of the light beam L, here, a light source. The light source unit generates and radiates the light beam L under the control of the control device 18. The scanning unit 44 is a mechanism that is configured to be capable of receiving the light beam L radiated from the light source unit 42 and adjusting an emission angle of the received light beam L. The scanning unit 44 adjusts the radiation position of the light beam L on the stage 32 by adjusting the emission angle of the light beam L. The scanning unit 44 adjusts the radiation position of the light beam L under the control of the control device 18. in the example of FIG. 1, the scanning unit 44 is a galvano mirror including a mirror 44A and a mirror 44B. The mirror 44A receives the light beam L from the light source unit 42 to reflect the received light beam toward the mirror 44B. The mirror 44A rotates around one axial direction, for example, around an axis extending in the direction Z, under the control of the control device 18. The mirror 44B receives the light beam 11, from the mirror 44A to reflect the received light beam toward the lens 46. The mirror 44B rotates around one axial direction, for example, around an axis extending in the direction X, under the control of the control device 18. The scanning unit 44 scans the radiation position of the light beam 11, on the stage 32 in the direction X and the direction Y by rotating the mirrors 44A and 44B.

The lens 46 collects the light beam L emitted from the mirror 44B to emit the collected light beam toward an emission port 40A of the housing 40. The emission port 40A is an opening provided in the housing 40 and is an opening from which the light beam L is emitted. The protection unit 48 is a member that covers the emission port 40A. The protection unit 48 is made of a material through which the light beam L can be transmitted, and in the present embodiment, is made of, for example, glass having translucency. The light beam L emitted from the scanning unit 44 passes through the lens 46 and the protection unit 48 and is radiated onto the stage 32. Since the powder P is supplied to the space AR on the stage 32, the light beam 11, is radiated to the powder P on the stage 32. The powder P is melt-solidified (melted and then solidified) or sintered at a position where the light beam L is radiated. In addition, since the powder P is supplied along the plane PL, the plane PL serves as an irradiation plane on which the powder P is irradiated with the light beam L. The control device 18 will be described below.

By radiating the light beam L onto the powder P on the stage 32 in this way, the metal 3D printer 1 forms a solidified layer in which the powder P is solidified or sintered. After that, the formation of the solidified layer is repeated by moving the stage 32 to the direction Z2 side to mold the space AR on the stage 32 and supplying the powder P to the space AR to radiate the light beam L. The metal 3D printer 1 molds the built part 61 by laminating solidified layers in this way.

Here, quality such as the strength of the built part M is significantly affected by the state of the radiated light beam L. The state of the light beam L is, for example, the output (intensity) of the light beam L, the intensity distribution, the radiation position on the stage 32, and the like. For example, in a case where the intensity of the light beam L is low or the radiation position of the light beam L on the stage deviates significantly from a target position, the quality of the built part P is reduced. Additionally, the light beam L is radiated onto the stage 32 through the protection unit 48. Therefore, even in a case where there is a problem with the protection unit 48, such as fumes or other foreign matter adhering to a surface 48A of the protection unit 48 or the protection unit 48 being damaged, the state of the light beam L is affected, and the quality of the built part M is affected. Therefore, in the present embodiment, the calibration unit 50 and the detection device 70 are attached to the metal 3D printer 1 to detect the state of the light beam L to prompt a calibration of the light beam L as necessary.

(Configuration of Calibration Unit and Detection Device)

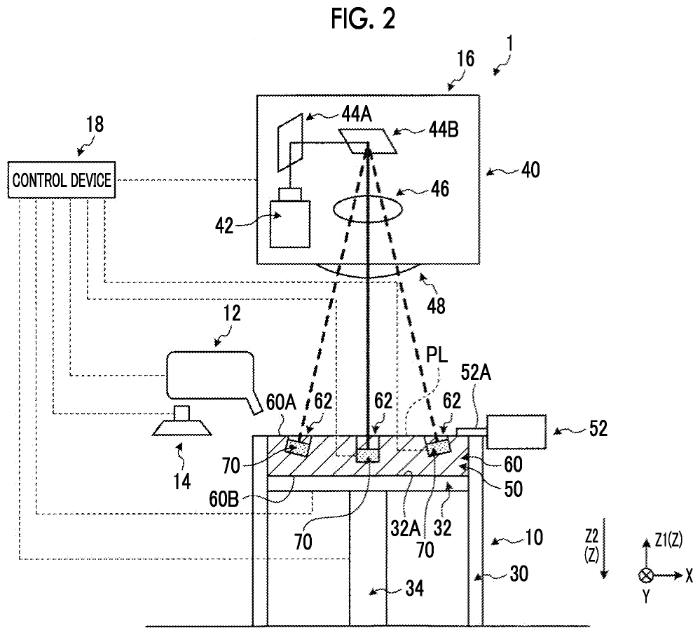

FIG. 2 is a schematic view of the metal 3D printer according to the present embodiment. FIG. 2 schematically illustrates the metal 3D printer 1 in a case where the calibration unit 50 and the detection device 70 are attached. As illustrated in FIG. 2, the calibration unit is attached onto the stage 32. Specifically, the calibration unit 50 has a base portion 60 and an attachment portion 62. The base portion 60 is a member that is configured to be attachable to the stage 32. The base portion 60 is a plate-like member in the present embodiment, and is attached to the stage 32 such that a surface 60A faces the direction Z1 side and a back surface 60B, which is a surface opposite to the surface 60A, faces the direction Z2 side. That is, the base portion 60 is attached onto the stage 32 such that a back surface 60B faces and comes into contact with the surface 32A of the stage 32. Therefore, in the calibration unit 50, the surface 60A and the back surface 60B of the base portion 60 are along the directions X and Y.

Additionally, in the present embodiment, the base portion 60 is attached onto the stage 32 such that the surface 60A is along the plane Pt (irradiation plane of the light beam L). For example, the metal 3D printer 1 may have a positioning portion 52 for positioning the base portion 60. The positioning portion 52 is configured to perform positioning of the base portion 60 in the direction Z. For example, the positioning portion 52 is attached to the housing 30 and has a member 52A extending along the plane Pt in a state of being attached to the housing 30. For example, the calibration unit 50 disposed on the stage 32 is at an appropriate position where the surface 60A extends along the plane Pt in a state in which the surface 60A of the base portion 60 is in contact with the member 52A. In this case, the calibration unit 50 can be attached at the appropriate position by driving the movement mechanism 34 to move the stage 32 in a state in which the calibration unit 50 is placed on the stage 32 and bringing the surface 60A of the base portion 60 into contact with the membei- 52A. However, the calibration unit 50 is not limited to being disposed such that the surface 60A extends along the plane Pt and may be disposed at a position where the light beam L can be appropriately detected.

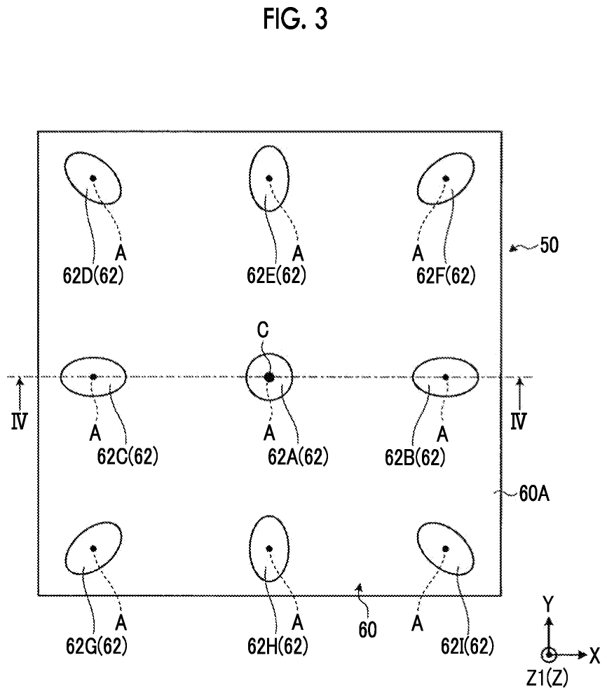

FIG. 3 is a top view of the calibration unit according to the present embodiment. FIG. 3 is a view of the calibration unit 50 as viewed from the direction Z1. The attachment portion 62 is provided on the base portion 60 and configured such that the detection device 70 for detecting the light beam L is attachable thereto. In the present embodiment, the attachment portion 62 is an opening provided on the surface 60A of the base portion 60, that is, an attachment hole portion. Additionally, as illustrated in FIG. 3, a plurality of the attachment portions 62 are provided, and the attachment portions 62 are provided at mutually different positions in the direction X and the direction Y. Here, a central axis of the base portion 60 along the direction Z is defined as a central axis C. It can be said that the central axis C is the central position of the surface 60A of the base portion 60 as viewed from the direction Z. In this case, the attachment portions 62 are preferably provided at a position overlapping the central axis C (central position of the surface 60A) and a position different from the position overlapping the central axis C. In the example of FIG. 3, attachment portions 62A, 62B, 62C, 62D, 62E, 62F, 62G, 62H, and 62I are provided as the attachment portions 62. The attachment portion 62A is provided at a position overlapping the central axis C. The attachment portion 62B is provided on the direction X side of the attachment portion 62A, and the attachment portion 62C is provided on the side of the attachment portion 62A opposite to the direction X. The attachment portions 62D, 62E, and 62F are provided on the direction Y sides of the attachment portions 62C, 62A, and 62B, respectively. The attachment portions 62G, 62H, and 62I are provided on the sides of the attachment portions 62C, 62A, and 62B opposite to the direction Y, respectively. However, the number and positions of the attachment portions 62 are not limited to the example of FIG. 3, but at least the attachment portion 62A located at the position overlapping the central axis C and the attachment portions 62D, 62F, 62G, and 621 at four corners of the rectangular surface 60A of the base portion 60 as viewed from the direction Z are preferably provided.

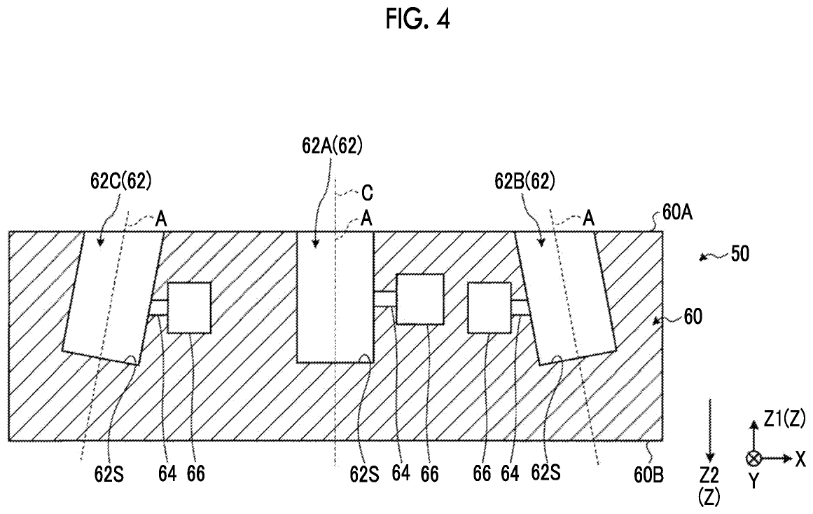

FIG. 4 is a cross-sectional view of the calibration unit according to the present embodiment. FIG. 4 is a cross-sectional view as seen from arrow IV-IV of FIG. 3 As illustrated in FIG. 4, the attachment portions 62 are open to be inclined in mutually different orientations. In other words, when the central axis of each attachment portion 62 is defined as a central axis A, the orientations of the central axes A of the respective attachment portions 62 are different from each other, in other words, the central axes A of the respective attachment portions 62 have mutually different angles. Additionally, the central axis A of each attachment portion 62 faces in a direction different from the direction X and the direction Y, in other words, intersects the surface 60A of the base portion 60. Moreover, as illustrated in FIGS. 3 and 4, central axes AX of the respective attachment portions 62 have different angles to face a central position side (central axis C side) of the surface 60A of the base portion 60. Specifically, the central axis AX of each attachment portion 62 is inclined to face the central position side, that is, the inside in the radial direction of the surface 60A of the base portion 60 toward the direction Z1 side. However, the central axis A of the attachment portion 62A overlapping the central axis C among the central axes A of the attachment portions 62 is along the central axis C. In addition, the inside in the radial drection herein. is a direction toward the central axis C side as viewed from the direction Z. Additionally, a bottom surface 62S of each attachment portion 62 is orthogonal to the central axis A. The bottom surfaces 62S have mutually different angles to be inclined toward the central position side (central axis C side) of the surface 60A of the base portion 60.

Additionally, as illustrated in FIG. 4, the calibration unit 50 has a passage 64 and a heat absorbing portion 66. The passage 64 is an opening provided inside the base portion 60, and one end portion thereof communicates with the attachment portion 62. Additionally, the other end portion of the passage 64 communicates with the heat absorbing portion 66. The heat absorbing portion 66 is provided with a cooling medium for cooling the light beam L. The heat absorbing portion 66 is, for example, a space provided inside the base portion 60, and has the cooling medium provided inside. Examples of the cooling medium include water and the like. As illustrated in FIG. 4, in the present embodiment, the passage 64 and the heat absorbing portion 66 are provided for each attachment portion 62, in other words, a plurality of passages 64 are provided corresponding to the respective attachment Portions 62. That is, one passage 64 and one heat absorbing portion 66 are provided for one attachment portion 62.

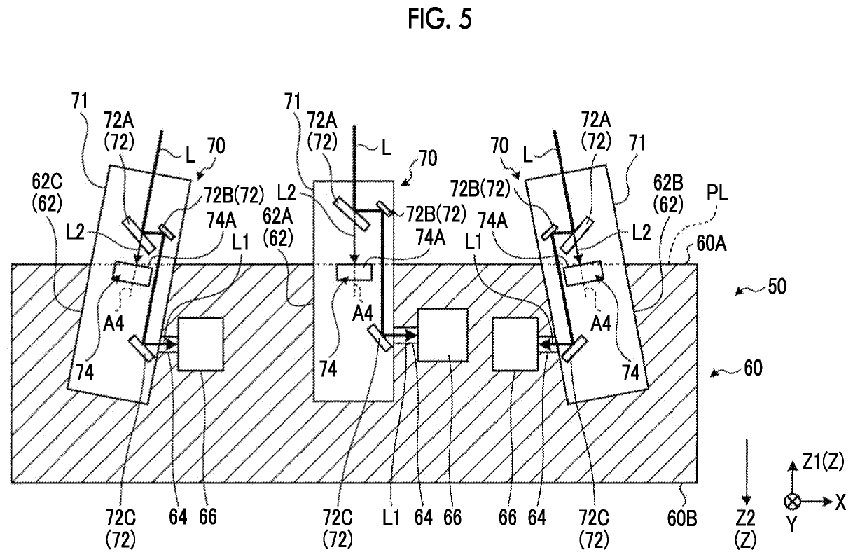

FIG. 5 is a schematic view illustrating a case where the detection device is attached to the calibration unit. The detection device 70 is attached to the calibration unit 50 configured as described above. The detection device 70 is attached to the attachment portion 62. In the example of the present embodiment, the detection devices 70 are attached to all the attachment portions 62 one by one but may be attached to only some attachment portions 62. Each detection device 70 is a device that detects the light beam L, and in the present embodiment, is an imaging device that images the light beam L. As illustrated in FIG. 5, the detection device 70 includes a housing 71, a beam damper portion 72, and an imaging element 74 which is a detection element. The housing 71 houses the beam damper portion 72 and the imaging element 74 inside. The housing 71 is inserted into the attachment portion 62 and attached to the attachment portion 62. The imaging element 74 is, for example, an image sensor such a charge coupled device (CCD), and receives the radiated light beam L to convert the received light beam L into an electric signal. The detection device 70 generates an image of the light beam on the basis of the electric signal generated by the imaging element 74. Since the brightness of the image of the light beam L differs depending on, for example, the intensity of the light beam L it can be said that the detection device 70 detects the state of the light beam L.

As described above, since the orientations of the central axes A of the attachment portions 62 are different from each other, the respective detection devices 70 are attached to the attachment portions 62 such that the orientations thereof are different from each other. In other words, the attachment portions 62 are provided at mutually different angles such that the orientations of the detection devices 70 to be attached thereto are different from each other. Moreover, since the central axis A of each attachment portion 62 faces the central position side (central axis C side) of the surface 60A of the base portion 60, the detection device 70 is attached to the attachment portion 62 to face the central position side (central axis C side) of the surface 60A of the base portion 60. In other words, the attachment portions 62 are provided at mutually different angles such that the detection devices 70 to be attached thereto intersect the surface 60A of the base portion 60 and face the center side (central axis C side) of the surface 60A. In addition, it can be said that the orientation of each detection device 70 herein is the orientation of the imaging element 74, for example, the orientation. of a light receiving surface 74A on which the imaging element receives the light beam L. Additionally, since the detection device 70 receives the light beam L on the light receiving surface 74A to perform detection, the orientation of the detection device 70 may be rephrased as a detection direction of the detection device 70. That is, it can be said that the attachment portions 62 are provided at mutually, different angles such that the detection directions of the detection devices 70 to be attached thereto are different from each other. Each detection direction is, for example, a direction toward the direction Z1 side and a direction orthogonal to the light receiving surface 74A.

Here, the radiation position of the light beam L on the base portion 60 (stage 32) is scanned by the scanning unit 44 while an irradiation angle, that is, an angle between a traveling direction of the light beam L and the surface 60A of the base portion 60 (the surface 32A of the stage 32), is changed. The light beam L is radiated to be orthogonal to the surface 60A (surface 32A) at a predetermined position on the surface 60A of the base portion 60 (surface 32A of the stage 32), here at the central position of the surface 60A (surface 32A). That is, the irradiation angle is 90 degrees. On the other hand, the light beam L is not orthogonal to the surface 60A (surface 32A) at positions other than the predetermined position on the surface 60A (surface 32A), here at positions other than the central position, and the irradiation angle is an angle other than 90 degrees. In contrast, the attachment portions 62 are open at mutually different angles such that the light receiving surface 74A of each detection device 70 to be attached thereto i.s orthogonal to the traveling direction of the light beam L radiated toward each attachment portion 62. That is, in the present embodiment, by directing the central axes A of the attachment portions 62 toward the central position side of the surfaces 60A, the light receiving surfaces 74A of all the detection devices 70 are orthogonal to the traveling direction of the light beam L. In other words, assuming that the central axis of each imaging element 74 is a central axis AA, the attachment portion 62 is open at an angle such that the central axis A4 of the imaging element 74 is along the traveling direction of the light beam L.

Additionally, as illustrated in FIG. 5, the detection device 70 is preferably attached to the attachment portion 62 such that the light receiving surface 74A of the imaging element 74 is at the same position as the surface 60A of the base portion 60 in the direction Z. The surface 60A is at the same position as the plane PL, that is, the irradiation plane of the light beam L in the direction Z. Therefore, in the detection device 70, the light receiving surface 74A is at the same position as the plane Pt, that is, the irradiation plane of the light beam L. In other words, the attachment portion 62 mounts the detection device 70 such that the light receiving surface 74A of each imaging element 74 is at the same position as the irradiation plane of the light beam L in the traveling direction of the light beam L. In addition, in the example of FIG. 5, a central position of the light receiving surface 74A is the same position as the irradiation plane of the light beam L in the traveling direction of the light beam L.

The beam damper portion 72 emits only a part of the light beam L to be radiated to the detection device 70 attached to the attachment portion 62 to the imaging element 74. That is, the beam damper portion 72 reduces the intensity of the light beam L to cause the reduced light beam to reach the imaging element 74. In the example of FIG. 5, the beam damper portion 72 includes mirrors 72A, 72B, and 72C. The mirror 72A is provided closer to a side to which the fight. beam L is radiated than the imaging element 74, here closer to the direction Z1 than the imaging element 74. That is, the mirror 72A is provided on an upstream side of the imaging element 74 in the traveling direction of the light beam L. The mirror 72A has, for example, a partially reflective coating provided on a surface thereof, transmits a part of the received light beam L, and reflects the rest. In the present embodiment, the light beam 12, which is the light beam L transmitted through the mirror 72A, is emitted to the imaging element 74. Therefore, the imaging element 74 receives the light beam 12 to image the light beam 12.

On the other hand, the light beam L1, which is the light beam L reflected by the mirror 72A, is reflected by the mirrors 72B and 72C, respectively, to be incident on the heat absorbing portion 66 through the passage 64. The light beam L1 is heat-absorbed by the cooling medium. of the heat absorbing portion 66. That is, the heat absorbing portion 66 receives the light beam L1 excluding the light beam L incident on the imaging element 74 in the light beam L radiated toward the attachment portion 62 (detection device 70), that is, the light beam L radiated to the mirror 72A of the beam damper portion 72, to absorb heat from the received light beam L1. In addition, in the example of FIG. 5, the light beam transmitted through the mirror 72A is made to be incident on the imaging element 74, but the light beam reflected by lie mirror 72A may be made to be incident on the imaging element 74.

The beam damper portion 72 preferably sets the intensity of the light beam L2 to, for example, 1% with respect to the intensity of the light beam L. However, the beam L2 is not limited to such an intensity. Additionally, the beam damper portion 72 is not limited to the structure described above and may have any structure. For example, the beam damper portion 72 may receive the light beam L radiated from the irradiation unit 16 toward the detection device 70 and separate the received light beam L into the light beam L1 and the light beam L2. Additionally, the beam damper portion 72 may not be provided.

(Determination of State of Light Beam)

Next, a method of determining the state of the light beam L using the detection device 70 will be described. In the present embodiment, the state of the light beam L is determined by the control of the control device 18, and whether or not the built part M can be manufactured is determined depending on the determination result. Therefore, first, the configuration of the control device 18 will be described.

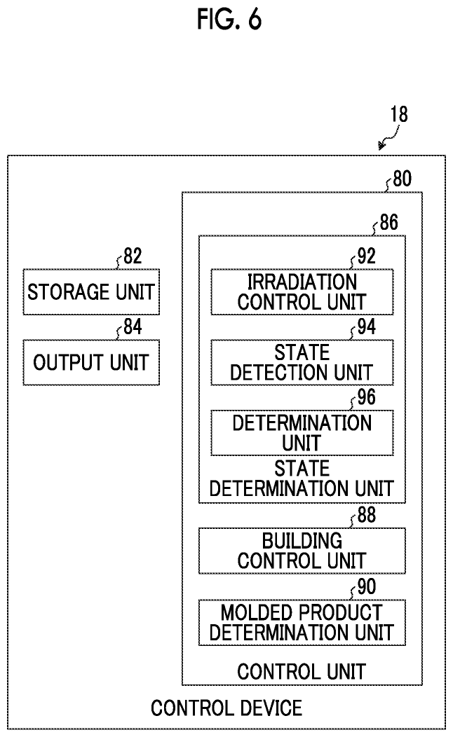

FIG. 6 is a block diagram of the control device according to the present embodiment. The control device 18 is, for example, a computer, and has a control unit 80, a storage unit 82, and an output unit 84, as illustrated in FIG. 6. The control unit 80 is a calculation unit, that is, a central processing unit (CPU). The storage unit 82 is a memory that stores the calculation contents of the control unit 80, program information, and the like. For example, the storage unit 82 includes at least one of a random access memory (RAM), a read only memory (ROM), and an external storage devices such as a hard disk drive (HDD). The output unit 84 is an output device that outputs a detection result or the like of the state of the light beam L, and in the present embodiment, is a display device that displays a detection result or the like of the state of the light beam L. In addition, the control device 18 may have an input unit such as a keyboard or a touch panel that receives a user input, for example.

The control unit 80 includes a state determination unit 86, a building control unit 88, and a molded product determination unit 90. The state determination unit 86, the building control unit 88, and the molded product determination unit 90 are realized by the control unit 80 reading software (programs) stored in the storage unit 82, and execute the processing described below.

The state determination unit 86 detects the state of the light beam L on the basis of the detection result of the light beam L detected by the detection device 70, to determine the state of the light beam L. The state determination unit 86 includes an irradiation control unit 92, a state detection. unit 94, and a determination unit 96. In addition, during the processing of the state determination unit 86, the calibration unit 50 is attached to the stage 32, and the detection device 70 is attached to each attachment portion 62 of the calibration unit 50.

The irradiation control unit 92 controls the irradiation unit 16 in a state in which the calibration unit 50 is attached to the stage 32, to cause the light beam L to be radiated toward each detection device 70 attached to the calibration unit 50. Each detection device 70 detects the radiated light beam L. That is, the detection device 70 images the light beam L via the imaging element 74 to generate an image of the light beam L radiated to the imaging element 74. In of words, it can be said that the image of the light beam L is the detection result of the light beam L. However, the detection device 70 may not generate the image of the light beam L. In this case, the electric signal, which is generated by the imaging element 74 and has a different output value depending on the intensity of the light beam L, is the detection result of the light beam L. That is, it can be said that the detection result of the light beam L detected by the detection device 70 is information on the intensity of the light beam L for each position (for each coordinate of a pixel of the imaging element 74).

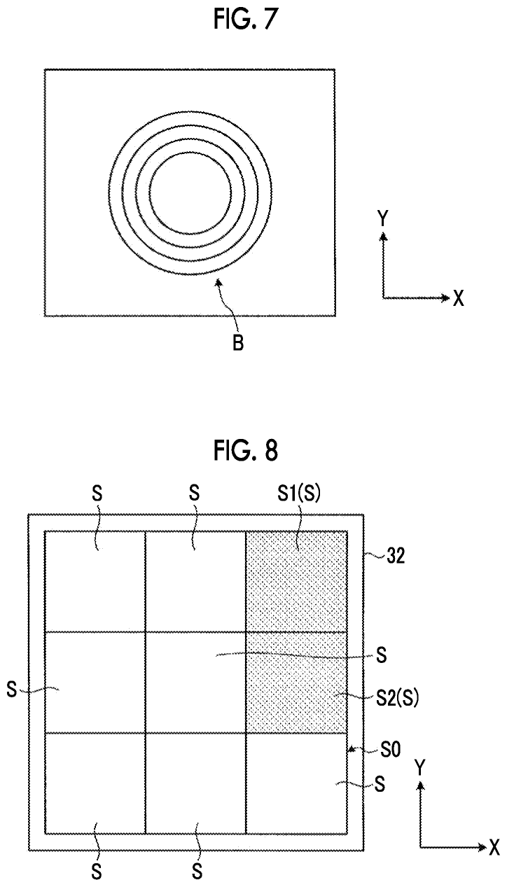

FIG. 7 is a view illustrating an example of the image of the light beam. As illustrated in FIG. 7, the image B of the light beam L is an image having different brightness depending on the intensity of the light beam L radiated to the imaging element 74. In addition, for convenience of description, FIG. 7 is an image in which the intensity, that is, the brightness, of the light beam L is discretely changed, but the actual image B of the light beam L is not limited to the example of FIG. 7 and may be an image in which the brightness changes continuously. Additionally, in the present embodiment, The imaging element 74 of the detection device 70 receives the light beam 12 to detect the light beam L2. Therefore, the image B is the image of the light beam L2. In this case, for example, the state determination unit 86 may correct the detection result of the light beam 12 to The detection result of the light beam L.

The detection device 70 detects the light beam L in this way. The detection devices 70 are provided at different positions on the calibration unit 50, that is, on the stage 32. Therefore, the respective detection devices 70 detect the light beams L radiated to the different positions on the stage 32.

Returning to FIG. 6, the state detection unit 94 acquires the detection result of the light beam L from each detection device 70. That is, the state detection unit 94 acquires the detection results of the light beams L radiated to the different positions on the stage 32. The state detection unit 94 acquires the images B of the respective light beams L radiated to the different positions on the stage 32 as the detection results of the light beams L. In a case where the detection device 70 does not generate any image B, the state detection unit 94 acquires the electric signals generated by the respective imaging elements 74 and generates the images B of the light beams L radiated to the different positions on the stage 32.

The state detection unit 94 detects the state of the light beam L on the basis of the detection result of the light beam L acquired from each detection device 70. The state detection unit 94 calculates the state of the light beam L from the detection result of the light beam L. In the present embodiment, the state detection unit 94 calculates an average output of the light beam L, the intensity distribution of the light beam L, the radiation position of the light beam L, and the intensity of the scattered light by the light beam L. The average output of the light beam L is an average value of the intensities of the light beam L radiated to the detection device 70. The state detection unit 94 calculates the brightness of the light beam L for each pixel on the basis of, for example, the brightness of each pixel of the image B, converts the brightness of the light beam L for each pixel into the intensity of the light beam L, and then averages the respective intensities to calculate the average output. Additionally, the intensity distribution of the light beam L refers to the distribution of the intensity of the light beam L. For example, the state detection unit 94 calculates a spot diameter at which the intensity of the light beam L is equal to or higher than a predetermined intensity. The radiation position of the light beam L refers to a position on the stage 32 where the light beam L is radiated, in other words, the coordinates, in the direction X and the direction Y, of a spot where the light beam L is radiated on the stage 32. The state detection unit 94 calculates, for example, a central position of the light beam L as the radiation position of the light beam L. Additionally, the intensity of the scattered light of the light beam L refers to the intensity of the scattered light generated by the light beam L being scattered by the Protection unit 48 or the like. In addition, in the present embodiment, as the state of the light beam L, the average output of the light beam L, the intensity distribution of the light beam L, the radiation position of the light beam L, and the intensity of the scattered light by the light beam L are all calculated. However, only some of them may be calculated. Additionally, the state detection unit 94 may calculate a separate parameter as the state of the light beam L. Additionally, the state detection unit 94 calculates a plurality of types of parameters as the state of the light beam L, but only one parameter may be calculated.

The state detection unit 94 detects the state of the light beam L for each position on the stage 32 by detecting the state of the light beam L for each detection result of each detection device 70.

The determination unit 96 determines whether or not the state of the light beam L is normal on the basis of the state of the light beam L detected by the state detection unit 94. The determination unit 96 acquires the detection result of the state of the light beam L from the state detection unit 94. The determination unit 96 compares the acquired detection result of the state of the light beam L with preset reference data to determine whether or not the state of the light beam L is normal. In the present embodiment, the determination unit 96 determines that the state of the light. beam L is normal in a case where the detection result of the state of the light beam L is within a numerical range of the preset reference data. On the other hand, in a case where the detection result of the state of the light beam L is out of the numerical range of the reference data, the determination unit 96 determines that the state of the light. beam L is not normal, that is, there is an abnormality.

In the present embodiment, the determination unit 96 determines whether or not the average output of the light beam L detected by the state detection an it 94 is within a predetermined. output range. The predetermined output range is, for example, a range of 90% or more and 110% or less with respect to a predetermined control value. Additionally, the determination unit 96 determines whether or not the spot diameter at which the intensity of the light beam L is equal to or higher than the predetermined intensity is within a predetermined diameter range. The predetermined diameter range is, for example, a range of 90% or more and 110% or less with respect to a predetermined diameter. Additionally, the determination unit 96 determines whether or not a distance between the radiation position of the light beam L detected by the state detection unit 94 and a predetermined position is within a predetermined distance range. The “within a predetermined distance range” is, for example, a range in which the distance is 0.1 mm with respect to the coordinates of the predetermined position. Additionally, the determination unit 96 determines whether or not the intensity of the scattered light by the light beam detected by the state detection unit 94 is within a predetermined intensity range. The “within a predetermined intensity range” is, for example, a range in which the rate of increase with respect to a predetermined intensity is within 20%. The predetermined intensity is, for example, the intensity, of the scattered light i.n a case where an unused protection unit 48 is used.

In a case where the states of a plurality of types of light beams L are detected, and in a case where the states of all the light beams L satisfy conditions, that is, in a case where the states of all the light beams L are within the numerical range of the reference data, the determination unit. 96 determines that the states of the light beams L are normal. In other words, the determination unit 96 determines that the states of the light beams L are not normal in a case where the states of at least some types of light beams L among the states of the plurality of types of light beams L do not satisfy the conditions. However, the determination unit 96 sets important parameters from the states of the plurality of types of light beams and determines that the state of the light beam L is normal in a case where the important parameters satisfy the conditions. The important parameters are, for example, the average output of the light beam L, the intensity distribution of the light beam L, and the radiation position of the light beam L. Knowing the three important parameters of the average output, the intensity distribution, and the radiation position, it is possible to determine required work tasks among calibration, cleaning, and oscillator repair or replacement. in addition to these, when the state of the scattered light is further known, it is possible to appropriately double-check whether or not the protection unit 48 needs to be cleaned or replaced.

Additionally, in a case where the state of the light beam L does not satisfy the conditions, that is, in a case where the state of the light beam L does not fall within the numerical range of the reference data, the determination unit 96 determines that the irradiation. unit 16 has an abnormality, and sets the required work tasks for eliminating the abnormality to return the state of the light beam L to its normal state. The determination unit 96 sets a required work task for each type of state of the light beam L that does riot satisfy the conditions. For example, in a case where the average output does not satisfy a condition, the determination unit 96 determines that an abnormality has occurred in the light source unit 42, and sets the repair or replacement of the light source unit 42 as a required work task. Additionally, in a case where the intensity distribution, that is, the spot diameter at which the intensity of the light beam L is equal to or higher than the predetermined intensity, does not satisfy a condition, the determination unit 96 determines that an abnormality has occurred in the protection unit 48, and sets the cleaning or replacement of the protection unit 48 as a required work task. Additionally, in a case where the intensity distribution does not satisfy a condition, the determination unit 96 may determine that an abnormality has occurred in the scanning unit 44, and set the calibration of he scanning unit 44 as a required work task. Additionally, in a case where the radiation position. of the light beam L does not satisfy a condition, the determination unit 96 determines that an abnormality has occurred. in the scanning unit 44, and sets the calibration of the scanning unit 44 as a required work task. In a case where the intensity of the scattered light does not satisfy a condition, the determination unit 96 determines that an abnormality has occurred in the protection unit 48, and sets the cleaning or replacement of the protection unit 48 as a required work task. The determination unit 96 causes the output unit 84 to output the information on the required work tasks that have been set, and notifies the user of the work tasks.

The determination unit 96 determines whether or not the state of the light beam L is normal for each position on the stage 32 by performing such a determination for each detection result of each detection device 70.

Additionally, the determination unit 96 may output a determination result to the output unit 84. That is, the determination unit 96 may display the determination result of the state of the light beam on the output unit 84. In this case, the determination unit 96 causes the output unit 84 to display a determination result for each position on the stage 32. Additionally, in a case where there are a plurality of types of light beam states, the determination unit 96 may display the determination result for each position on the stage 32 for each type of the state of the light beam L.

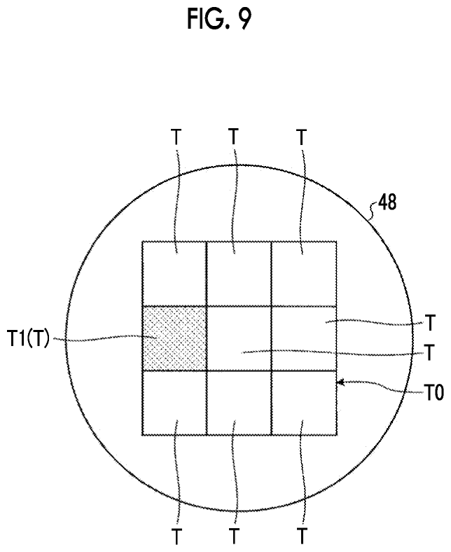

FIGS. 8 and 9 are views illustrating display examples of determination results. FIG. 8 illustrates an example of an image S0 illustrating whether or not the average output of the light beam satisfies a condition as a determination result for each position on the stage 32. The image S0 includes a plurality of images S. Images correspond to positions the stage 32 and are respectively arranged in a matrix in the direction X and the direction Y at the positions on the stage 32. Additionally, each image S shows the determination result of the average output of the light beam L derived from the detection result of one detection device 70, and the position of the image S on the stage 32 corresponds to the position of the detection device 70. The determination unit 96 can easily notify the user at which position on the stage 32 the light beam L cannot be normally, radiated, for example, by changing the display content of the image S depending on the determination result. In the example of FIG. 8, the average outputs of the light beams L do not satisfy the condition at positions corresponding to an image S1 closest to the direction X side and closest to the direction Y side and an image S2 adjacent to the side of the image S1 opposite to the direction Y Therefore, the display contents, for example, colors of the images S1 and S2, are different from those of the other images S.

Additionally, the determination unit 96 can associate a position on the protection unit 48 with the position on the stage 32 on the basis of the traveling direction of the light beam L. Additionally, as described above, the determination unit 96 can determine whether or not an abnormality has occurred in the protection unit 48 on the basis of the state of the light beam L. Therefore, as illustrated in FIG. 9, a determination result may be shown for each position on the protection unit 48 instead of the position on the stage 32. FIG. 9 illustrates an example of an image T0 showing whether or not an abnormality has occurred in the protection unit 48 for each position of the protection unit 48. The image T0 also includes a plurality of images T corresponding to the positions on the protection unit 48, and the images T are respectively arranged at the positions of the protection unit 48. In the example of FIG. 9, an abnormality has occurred at the position of the protection unit 48 corresponding to an image T1, and the display content (here, color) of the image T1 is different from the display contents of the other images T. In the example of FIG. 9, it can be said that the user is notified of the fact that the protection unit 48 needs to be cleaned at the position corresponding to the image T1.

Returning to FIG. 6, in a case where the determination unit 96 determines that the state of the light beam L is normal, the building control unit 88 controls the irradiation unit 16 and the powder supply unit 12 to mold the built part M. The building control unit 88 causes the built part M to be molded in a case where it is determined that the states of the light beams L are normal at all positions on the stage 32. However, in a case where it is determined that the states of the light beams L are not normal at some of the positions on the stage 32, the building control unit 88 may cause the built part M to be molded, using only regions other than. the positions determined to be abnormal. That is, it is possible to suppress molding defects of the built part M by performing molding only in regions where the states of the light beams L are normal, excluding the regions where the states of the light beams L are not normal.

Additionally, the molded product determination unit 90 determines the quality of the built part M molded under the control of the building control unit 88. The quality of the molded built pare M, such as strength and dimensions, is evaluated by, for example, a measuring device separate from the metal 3D printer 1. The molded product determination unit acquires a quality evaluation result of the built part M by another device to determine whether or not there is an abnormality in the metal 3D printer 1 on the basis of the evaluation result of the quality of the built part M. Since the built part M is manufactured in a case where it is determined that there is no abnormality in the light beam L, it is considered that there is no abnormality in the irradiation unit 16 when the manufacture of the built part M is permitted. in a case where there is nevertheless an abnormality in the quality of the built part M, that is, i.n a case where it is determined that there is no abnormality in the light beam L and that there is an abnormality in the built part M, the molded product determination unit 90 determines that an abnormality has occurred in a device other than the irradiation unit 16 of the metal 3D printer 1, to determine in which device other than the irradiation unit 16 an abnormality has occurred. For example, the molded product determination unit on determines whether there is an abnormality in at least one of a recoater and the gas supply unit on the basis of the determination result that there is no abnormality in the light beam L and the quality evaluation result of the built part M. Since the recoater is performed by the powder supply unit 12 and the blade 14, the abnormality of the recoater refers to the abnormality of the powder supply unit 12 or the blade 14. Additionally, the gas supply unit is a device that supplies the inert gas as described above For example, in a case where there is no abnormality in the light beam L and the variation of a threshold value or more has occurred in the quality of the built part M in a direction (here, the direction X) in which the recoater is performed, the molded product determination unit 90 determines that there is an abnormality in the recoater. Additionally, in a case where there is no abnormality in the light beam L and the variation of a threshold value or more has occurred in the quality of the built part M in the direction (here, the direction Y) in which the inert gas is supplied, the molded product determination unit 90 determines that there is an abnormality in the gas supply unit.

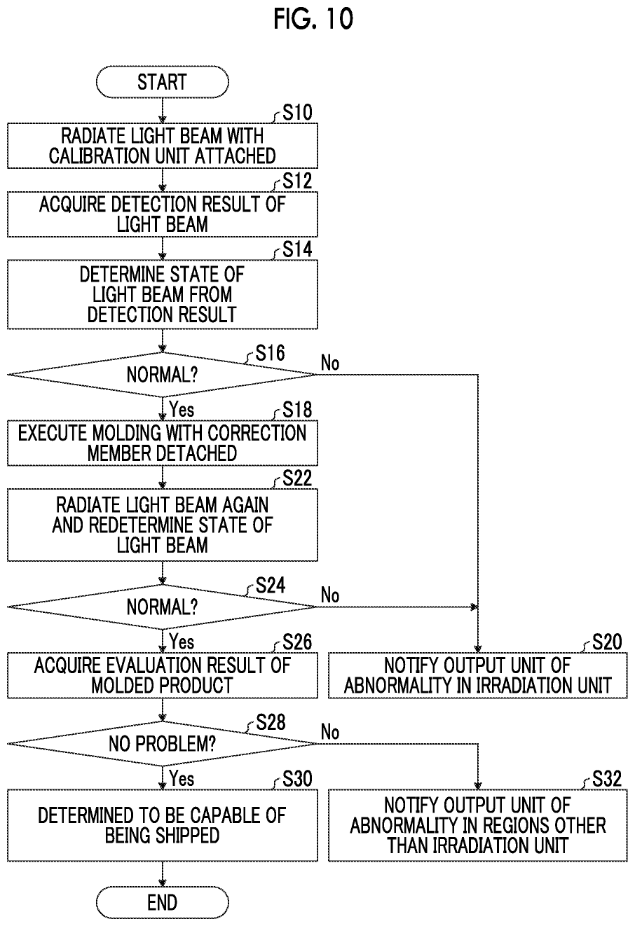

The control device 18 has the configuration as described above. Next, a control flow of the control device 18 will be described. FIG. 10 is a flowchart illustrating the control flow of the control device according to the present embodiment. As illustrated in FIG. 10, the control device 18 controls the irradiation unit 16 with the irradiation control unit 92 in a state in which the calibration unit 50 is attached to the stage 32, to cause the light beam L to be radiated toward each detection device 70 attached to the calibration unit 50 (Step S10). The detection device 70 detects the radiated light beam L, and the control device 18 acquires a detection result of the light beam L from the detection device 70 with the state detection unit 94 (Step S12). Then, the control device 18 detects the state of the light beam L from the detection result of the light beam L with the state detection unit 94 to determine the state of the light beam L with the determination unit 96 (Step S14). In a case where it is determined that the state of the light beam L is normal (Step S16; Yes), the control device 18 controls the irradiation unit 16 and the powder supply unit 12 with the building control unit 88 in a state in which the calibration unit 50 is removed from the stage 32, to execute the molding of the built part M (Step S18). In addition, in a case where it is determined that the state of the light beam L is not normal (Step S16; No), the state detection unit 94 notifies the output unit 84 of a determination result, here the fact that there is an abnormality in the irradiation unit 16 (Step S20).

When the molding of the built part M is completed in Step S18, the control device 18 attaches the calibration unit 50 again to cause the light beam L to be radiated to the detection device 70 to redetermine the state of the light beam L (Step S22). The redetermination processing in Step S22 is the same as the processing from Step S10 to Step S16. As a result of the redetermination, in a case where it is determined that the state of the light beam L is not normal (Step S24; No), the processing proceeds to Step S20, and the state detection unit 94 notifies the irradiation unit 16 of a determination result, here the fact that there is an abnormality in the output unit 84. As a result of the redetermination, in a case where the state of the light beam L is normal (Step S24; Yes), for example, the quality, such as strength and dimensions, is evaluated by a measuring device separate from the metal 3D printer 1, and the control device 18 acquires a quality evaluation result of the built part M with the molded product determination unit 90 (Step S26). The molded product determination unit 90 determines whether or not there is a problem with the quality of the built part M on the basis of the quality evaluation result of the built part M (Step S28), and in a case where there is no problem (Step S28; Yes), the molded product determination unit 90 determines that the built part M can be shipped (Step S30). In a case where there is a problem with the quality of the built part M (Step S28; No), the molded product determination unit 90 determines that there is an abnormality in a unit (for example, the powder supply unit. 12, the blade 14, the gas supply unit, or the like) of the metal 3D printer 1 other than the irradiation unit 16, and notifies the output unit 84 of the fact that there is an abnormality in the unit of the metal 3D printer 1 other than the irradiation unit 16 (Step S32).

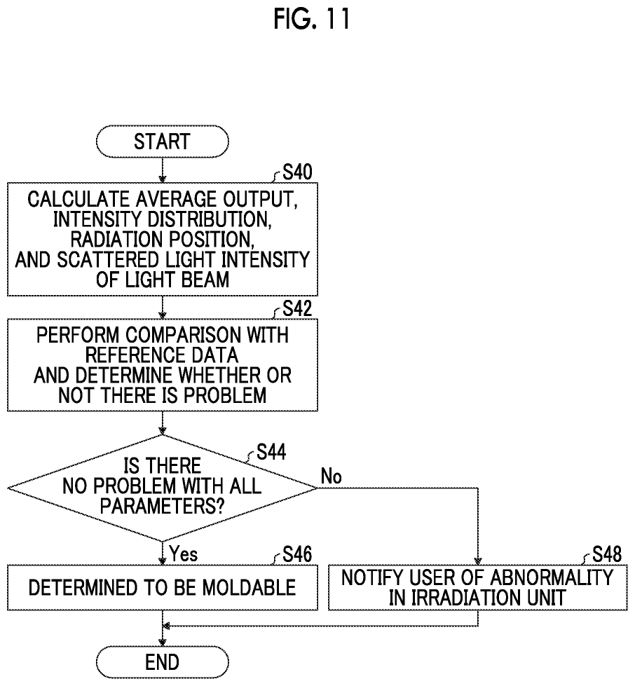

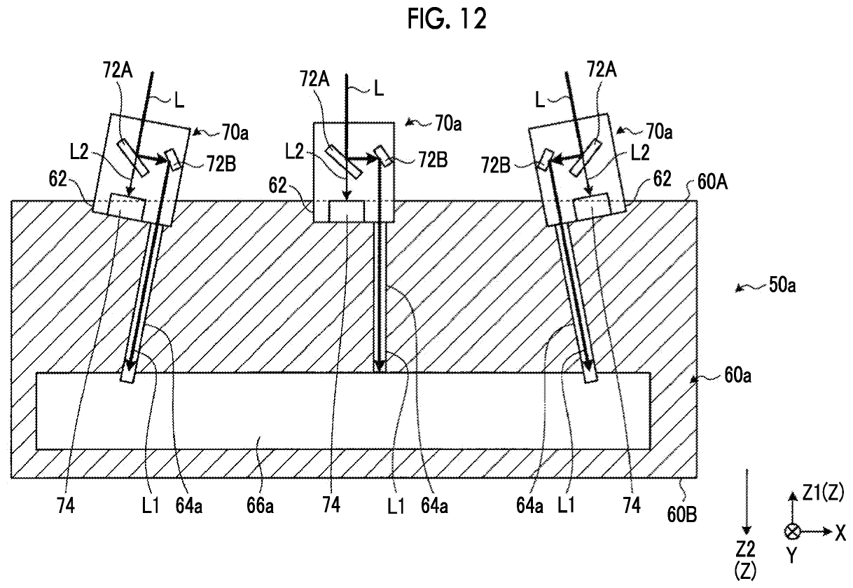

Additionally, next, an example of a flow of determining the state of the light beam L, that is, the determination in Step S16 will be described with a flowchart. FIG. 11 is a flowchart illustrating the flow of determining the state of the light beam. The flow of FIG. 11 shows an example of the flow of determination in Step S16. As illustrated in FIG. 11, the state detection unit 94 calculates the state of the light beam L, here the average output, the intensity distribution, the radiation position, and the scattered light intensity of the light beam L, from the detection result of the light beam L acquired from the detection device 70 (Step S40). The determination unit 96 acquires the state of each light beam L detected by the state detection unit 94 to compare the acquired state with each reference data to determine whether or not there is a problem with the state of the light beam L (Step S42). Then, in a case where there are no problems with all the parameters, here the average output, the intensity distribution, the radiation position, and the scattered light intensity of the light beam L (Step S44; Yes), that is, in a case where the states of all the types of light beams L satisfy the conditions, the determination unit 96 determines that the built part M can be molded (Step S46). On the other hand, in a case where there are problems with at least some of all the parameters (Step S44; No), the determination unit 96 notifies the user of the fact that there is an abnormality in the irradiation unit 16 (Step S48). However, as described above, in a case where there are no problems with the important parameters among all the parameters, the determination unit 96 may determine that the built part M can be molded even in a case where parameters other than the important parameters are not normal.

As described above, the calibration unit 50 according to the present embodiment is a calibration unit for the metal 3D printer 1 that radiates the light beam L to the powder P to mold the built part M. The calibration. unit 50 has the base portion 60 and the attachment portion 62. The base portion 60 is attached to the stage 32 that is irradiated with the light beam L of the metal 3D printer 1. The attachment portion 62 is provided on the base portion 60 and has the detection device 70 for detecting the light beam L attached thereto. The plurality of attachment portions 62 are provided, and the respective attachment portions 62 are provided at mutually different positions on the base portion 60. Additionally, the respective attachment portions 62 are provided at mutually different angles such that the detection directions of the detection devices 70 to be attached thereto are different from each other.

Here, the quality of the built part M is significantly affected by the state of the radiated light beam L. The calibration unit 50 according to the present embodiment is attached to the stage 32 by the base portion 60 and is configured such that the detection device 70 for detecting the light beam L is attachable thereto. Therefore, when the calibration. unit 50 is attached to the metal 3D printer 1, the state of the light beam L can be appropriately detected, and the characteristics of the light beam L can be appropriately calibrated as necessary. Additionally, the traveling direction of the light beam L differs for each radiation position on the stage 32. Therefore, there is a case where the state of the light beam L differs depending on each radiation position on the stage 32. For example, the light beam L passes through a different position on the protection unit 48 for each. radiation position on the stage 32. In this case, when foreign matter adheres to a partial region of the protection unit 48 or the partial region is damaged, there is a concern that there is a problem. with the state of the light beam L radiated to another radiation position even if there is no problem with the light beam L radiated to a certain radiation position. In such a case, there is a possibility that the state of the light beam L is not appropriately detected, for example, even if the light beam L is detected at only one radiation position. In contrast, since the calibration unit 50 according to the present embodiment is provided with the plurality of attachment portions 62 to which the detection devices 70 are attached, the states of the light beams L can be detected at the plurality of radiation positions, and the states of the light beams T, can be appropriately detected. Moreover, in order for the detection device 70 to appropriately detect the light beam L, there is a case where it is necessary to maintain the irradiation angle at which the light beam L is radiated at a predetermined. angle such as a right angle however, the irradiation angle at which the light beam L is radiated differs depending on the radiation position. Therefore, there is concern that the detection device 70 cannot appropriately detect the light beam L because the irradiation angle differs depending on a position where the Light beam is provided. In contrast, in the calibration unit 50 according to the present embodiment, the orientation of the detection device 70 is made different for each position. Therefore, it is possible to maintain an appropriate irradiation angle at each position, and the light beam L can be appropriately detected at each position.

Additionally, the respective attachment portions 62 are provided at mutually different angles such that the detection directions of the detection devices 70 to be attached thereto intersect the surface 60A of the base portion 60 and face the center side (central axis C side) of the surface 60A of the base portion 60. The alignment of the metal 3D printer 1 is usually set such that the irradiation angle of the light beam L radiated to the central position of the stage 32 is a right angle. In contrast, in the calibration unit 50 according to the present embodiment, the attachment portion 62 is provided such that each detection device 70 faces the center of the surface 60A of the base portion 60 that overlaps the center of the stage 32. Therefore, according to the calibration unit 50 according to the present embodiment, all the detection devices 70 can receive the light beams L such that the irradiation angles are right angles, and the light beam L can be appropriately detected at each position.

Additionally, the respective attachment portions 62 are provided at mutually different angles such that the light receiving surface 74A of the imaging element 74 (detection element) of each detection device 70 to be attached thereto is orthogonal to the light beam L. Therefore, according to the calibration unit 50 according to the present embodiment, all the detection devices 70 can receive the light beams L such that the irradiation angles are right angles, and the light beam L can be appropriately detected at each position.

Additionally, the attachment portion 62 is provided with an opening, and the central axis A of the opening is inclined to face the center side (central axis C side) of the surface 60A of the base portion 60. According to the calibration unit 50 according to the present embodiment, since the central axis A of the opening faces the center side, the detection device 70 can be appropriately attached, and the light beam can be appropriately detected at each position. Additionally, the attachment portion 62 is an opening provided on the surface 60A of the base portion 60, and the bottom surface 62S inclined toward the center side (central axis C side) of the surface 60A of the base portion 60. According to the calibration unit 50 according to the present embodiment, since the bottom surface 62S is inclined toward the center side, the detection device 70 can be appropriately attached, and the light beam L can be appropriately detected at each position.

Additionally, the calibration unit 50 has the heat absorbing portion 66. The heat absorbing portion 66 receives the light beam L2 that is not incident on the imaging element 74 (detection element) of the detection device 70 attached to the attachment portion 62 in the light beam L radiated toward the attachment portion 62, to absorb heat from the received light beam L1. Since the calibration unit 50 has the heat absorbing portion 66, it is possible to prevent other devices and the like from being damaged due to the heat of the light beam L while appropriately detecting the light beam L.

Additionally, the plurality of heat absorbing portions 66 are provided corresponding to the respective attachment portions 62. Since the calibration unit 50 is provided corresponding to each of the attachment portions 62, it is possible to appropriately absorb the heat of the light beam L radiated toward each attachment portion 62 to prevent other devices from being damaged due to the heat of the light beam L.

Additionally, the metal 3D printer 1 according to the present embodiment has the calibration unit 50, the stage 32 to which the calibration unit 50 is attached, the detection device 70 attached to the attachment portion 62 of the calibration unit 50, the irradiation unit 16 that radiates the light beam L, and the powder supply unit 12 that supplies the powder P. Since the metal 3D printer 1 has the calibration unit 50 to which the detection device is attached, the light beam L can be appropriately detected at each position on the stage 32.

Additionally, the detection device 70 has the beam damper portion 72. The beam damper portion 72 is provided closer to the side (direction Z1 side) to which the light beam L is radiated than the imaging element 74 (detection element), has the light beam L radiated toward the detection device 70 incident thereon, and emits a part of the incident light beam L toward the imaging element 74. Since the detection device 70 receives only a part of the light. beam L from the imaging element 74 with the beam damper portion 72, it is possible to prevent the imaging element 74 from being damaged by a high-intensity light beam L.

Additionally, the metal 3D printer 1 further includes the control unit 80 that controls the molding of the built part M. The control unit 80 includes the irradiation control unit 92, the state detection unit 94, the determination unit 96, and the building control unit 88. The irradiation control unit 92 causes the light beam L to be radiated to the detection device 70 attached to the calibration unit 50 in a state in which the calibration unit 50 is attached to the stage 32. The state detection unit 94 acquires the detection result of the light beam L from the detection device 70 and detects the state of the light beam L for each position on the stage 32 on the basis of the acquired detection result of the light beam L. The determination unit 96 determines whether or not the state of the light beam L is normal on the basis of the state of the light beam detected by the state detection unit 94. In a case where it is determined that the state of the light beam L is normal, the building control unit 88 controls the irradiation unit 16 and the powder supply unit 12 to mold the built part M. The metal 3D printer 1 detects the state of the light beam L at each position on the stage 32 and determines whether or not molding is possible on the basis of the detection result. Therefore, according to the metal 3D printer 1, the molding of the built part M with the light beam L having an abnormal state can be suppressed, and a molding defect of the built part M can be suppressed. Additionally, the metal 3D printer 1 determines the state of the light beam L for each position. on the stage 32. Therefore, for example, in a case where there is an abnormality in the light beam L only in a partial region on the stage 32, is also possible to perform molding only in regions other than the region where the abnormality has occurred.

Additionally, the metal 3D printer 1 has the output unit 84. The output unit 84 displays the determination result of the state of the light beam L by the determination unit 96. According to the metal 3D printer 1, the user can be appropriately notified of the determination result. Additionally, the output unit 84 displays at least one of the determination result of the state of the light beam L for each position. on the stage 32 and the determination result of the state of the light beam L for each position of the protection unit 48 covering the emission port 40A of the irradiation unit 16, According to the metal 3D printer 1, it is possible to appropriately notify the user of which position of the stage 32 or the protection unit 48 is abnormal.

Additionally, in the present embodiment, in Step S12 of detecting the state of the light beam L, the average output, the intensity distribution, the radiation position, and the scattered light intensity of the light beam are calculated. Then, in Step S14 of determining whether or not the state of the light beam is normal, it is determined whether or not the state of the light beam L is normal on the basis of the average output, the intensity distribution, the radiation position, and the scattered light intensity of the light beam L. According to the present embodiment, since an abnormal state can be appropriately detected, a molding defect of the built part can be suppressed. Additionally, in the present embodiment, in Step S14 of determining whether or not the state of the light beam L is normal, it is determined whether or not the state of the light beam L is normal by comparing each of the average output, the intensity distribution, the radiation position, and the scattered light intensity of the light beam with the reference data. According to the present embodiment, since an abnormal state can be appropriately detected, a molding defect of the built part can be suppressed. Additionally, in Step S14 of determining whether or not the state of the light beam is normal, it is determined that the state of the light beam L is normal in a case where the average output, the intensity distribution, and the radiation position of the light beam among the average output, the intensity distribution, the radiation position, and the scattered light intensity of the light beam L satisfy the conditions. According to the present embodiment, since an abnormal state can be appropriately detected, a molding defect of the built part can be suppressed.

Additionally, the present embodiment has Step S20 of notifying the user of the fact that there an abnormality in the irradiation unit in a case where it is determined that the state of the light beam L is not normal. According to the built part molding method, the user can be appropriately notified of the determination result.

Next, another example of the calibration unit 50 will be described. FIG. 12 is a cross-sectional view illustrating another example of the calibration unit according to the present embodiment. As illustrated in FIG. 12, a calibration unit 50a according to another example is different from the calibration unit 50 illustrated in FIG. 4 in that the calibration unit 50a has one heat absorbing portion 66a common to the plurality of attachment portions 62. As illustrated in FIG. 12, the calibration unit 50a has a passage 64a and the heat absorbing portion 66a in a base portion 60a. Additionally, a detection device 70a attached to the attachment portion 62 has mirrors 72A and 72B as beam damper portions. One passage 64a is provided in each attachment portion 62. That is, one end portion of the passage 64a communicates with the attachment portion 62. On the other hand, the heat absorbing portion 66a is provided to communicate with the other end portion of each passage 64a. That is, the heat absorbing portion 66a is connected to each of the plurality of attachment portions 62. In the example of FIG. 12, the heat absorbing portion 66a is provided closer on the direction Z2 side than each attachment portion 62, that is, on a side opposite t.o the side to which the light beam L is radiated with respect to each attachment portion 62.

In FIG. 12, a part of the light beam L incident on each attachment portion 62 is transmitted through the mirror 72A and is incident on the imaging element 74 as the light beam 12. Then, a part of the light beam incident on each attachment portion 62 is reflected as the light beam 12 by the mirror 72A, passes through the mirror 72B and the passage 64a, and is incident on the heat absorbing portion 66a. The heat absorbing portion 66a absorbs heat from each incident Light beam L.

In this way, the heat absorbing portion 66a may be provided closer to the side opposite to the side to which the light beam L is radiated than the attachment portion 62 and the detection device 70. In this case, only one heat absorbing portion 66a may be provided corresponding to the plurality of attachment portions 62. By providing the heat absorbing portion 66a in this way, the shape of the calibration unit 50 can be simplified. In addition, the positions and number of the heat absorbing portions are not limited to the examples illustrated in FIGS. 4 and 12 and may be optional. Moreover, the calibration unit 50 may not have the heat absorbing portion. In this case, for example, a heat absorbing portion may be provided outside the calibration unit 50 such that the light beam L radiated to the calibration unit 50 is guided to the external heat absorbing portion.

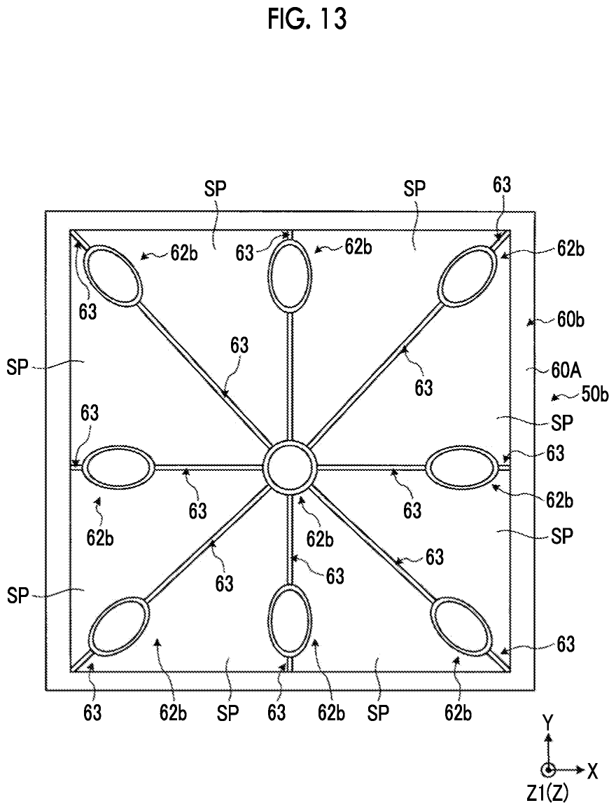

FIG. 13 is a top view illustrating another example of the calibration unit according to the present embodiment. As illustrated in FIG. 13, a calibration unit 50b according to another example is different from the calibration unit 50 illustrated in FIG. 3 in that the surface thereof is not a continuous plate-like member and has a large number of openings other than the attachment portion 62b. As illustrated in FIG. 13, the calibration unit 50b has a base portion 60b, an attachment portion 62b, and a connecting portion 63. As illustrated in FIG. 13, the base portion 60b is a frame-shaped member that opens inside. The attachment portion 62b is a ring-shaped member that opens inside, and the detection device 70 is attached to the inner opening. The connecting portion 63 is a member that connects an inner peripheral surface of the base portion 60b and an outer peripheral surface of the attachment portion 62b to each other and also connects the outer peripheral surfaces of the attachment portion 62b to each other. A space SP where no member is provided is formed at a spot where the attachment portion 62b and the connecting portion 63 are not provided, that is, between the inner peripheral surface of the base portion 60b and the outer peripheral surface of the attachment portion 62b, inside the base portion 60b, and allows the light beam L1 to pass therethrough in this way, the calibration unit 50b has a structure in which the ring-shaped attachment portion 62b is provided inside the frame-shaped base portion 60b. Accordingly, the space SP allowing the light beam L to pass therethrough is provided between the base portion 60b and the attachment portion 62b so that, for example, a passage configuration when the light beam L1 is guided to the heat absorbing portion can be simplified.

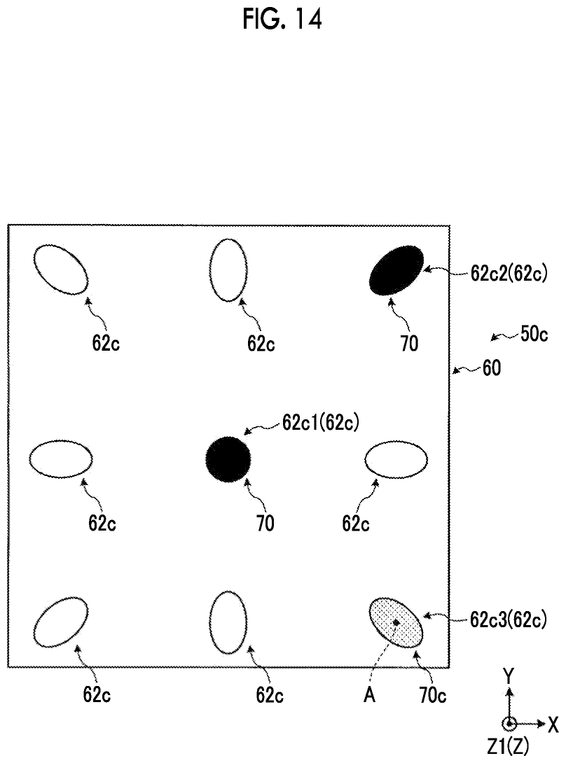

FIG. 14 is a top view illustrating another example of the calibration unit according to the present embodiment. As illustrated in FIG. 14, a calibration unit 50c according to another example has a plurality of attachment portions 62c. Each attachment portion 62c is different from the calibration unit 50 illustrated in FIG. 3 in that the inclination angle thereof, that is, the orientation of the central axis A, is variable. That is, in the calibration unit 50 illustrated in FIG. 3, the orientation of the attachment portion 62 is fixed, but the orientation of the attachment portion 62c is variable. By making the orientation of the attachment portion 62c variable in this way, for example, even when the attachment portion 62c is attached to a metal 3D printer having different dimensions, the angle of the attachment portion 62c can be adjusted so that the light beam L can be appropriately received according to the dimensions. Additionally, in the calibration unit 50c, a different detection device (sensor) may be attached to each attachment portion 62c, or detection devices may be attached only to some attachment portions 62c. FIG. 14 illustrates an example in which the detection devices 70 are attached to attachment portions 62c1 and 62c2 among the attachment portion 62c and a separate detection device 70c is attached to an attachment portion 62c3. By making the different detection devices attachable in this way, the versatility of inspection can be increased.

Although the embodiments of the present invention have been described above, the embodiments are not limited by the contents of the embodiments. Additionally, the aforementioned components include those that can be easily assumed by those skilled in the art and those that are substantially the same, that is, those having a so-called equal range. Moreover, the aforementioned components can be appropriately combined with each other. Moreover, various omissions, substitutions, or changes of the components can be made without departing from the scope of the aforementioned embodiments.

What is claimed is:

1. A calibration unit for a metal 3D printer that radiates a light beam to a powder to mold a built part, comprising:
a base portion that is attached to a stage to which the light beam of the metal 3D printer is radiated; and
a plurality of attachment portions that are provided on the base portion, have detection devices for detecting the light beam attached thereto, and are provided at mutually different positions,
wherein the respective attachment portions are provided at mutually different angles such that detection directions of the detection devices to be attached thereto are different from each other.

2. The calibration unit for a metal 3D printer according to claim 1,
wherein each of the attachment portions is provided with an opening, and a central axis of the opening is inclined to face a center side of a surface of the base portion.

3. The calibration unit a metal 3D printer according to claim 1,
wherein each of the attachment portions is an opening provided on one surface of the base portion, and a bottom surface thereof is inclined toward a center side of a surface of the base portion.

4. The calibration unit for a metal 3D printer according to claim 1,
wherein the base portion is a frame-shaped member that opens inside, and each of the attachment portions is a ring-shaped member provided inside the base portion.

5. The calibration unit for a metal 3D printer according to claim 1,
wherein the respective attachment portions are provided at mutually different angles such that the detection directions of the detection devices to be attached thereto intersect a surface of the base portion and face a center side of the surface of the base portion.

6. The calibration unit for a metal 3D printer according to claim 1,
wherein the respective attachment portions are provided at mutually different angles such that light receiving surfaces of detection elements of the detection device to be attached thereto are orthogonal to the light beam.

7. The calibration unit for a metal 3D printer according to claim 1,
wherein each of the attachment portions is provided with an opening, and a central axis of the opening is variable.

8. The calibration unit a metal 3D printer according to claim 1, further comprising:
a heat absorbing portion that receives a light beam other than that incident on a detection element of the detection device attached to each of the attachment portions in the light beam radiated toward the attachment portion, and absorbs heat from the received light beam.

9. The calibration unit for a metal 3D printer according to claim 8,
wherein the heat absorbing portion is provided closer to a side opposite to a side to which the light beam is radiated than the attachment portion.

10. The calibration unit for a metal 3D printer according to claim 9,
wherein the heat absorbing portion is connected to the plurality of attachment portions.

11. The calibration unit for a metal 3D printer according to claim 8,
wherein a plurality of the heat absorbing portions are provided corresponding to the respective attachment portions.

12. A metal 3D printer comprising:
the calibration unit according to claim 1;
the stage to which the calibration unit is attached;
the detection device that is attached to each of the attachment portions of the calibration unit;
an irradiation unit that radiates the light beam; and
a powder supply unit that supplies the powder.

13. The metal 3D printer according to claim 12,
wherein the detection device has a beam damper portion that is provided closer to a side to which the light beam is radiated than a detection element, has the light beam radiated toward the detection device incident thereon, and emits a part of the incident light beam toward the detection element.

14. The metal 3D printer according to claim 12, further comprising:
a control unit that controls molding of the built part,
wherein the control unit includes
an irradiation control unit that causes the light beam to be radiated to the detection device attached to the calibration unit in a state in which the calibration unit is attached to the stage;
a state detection unit that acquires a detection result of the light beam from the detection device and detects a state of the light beam for each position on the stage on the basis of the acquired detection result of the light beam;
a determination unit that determines whether or not the state of the light beam is normal on the basis of the state of the light beam detected by the state detection unit; and
a building control unit that controls the irradiation unit and the powder supply unit to mold the built part in a case where it is determined that the state of the light beam is normal.

15. The metal 3D printer according to claim 14, further comprising:
an output unit that displays a determination result of the state of the light beam by the determination unit.

16. The metal 3D printer according to claim 15,
wherein the output unit displays at least one of a determination result of the state of the light beam for each position on the stage and a determination result of the state of the light beam for each position of a protection unit that covers an emission port of the irradiation unit.

17. A built part molding method using a metal 3D printer having a calibration unit, a detection device attached to an attachment portion of the calibration unit, an irradiation unit that radiates a light beam, a powder supply unit that supplies a powder, and a stage to which the calibration unit is attached, the calibration unit including a base portion that is attached to a stage to which the light beam of the metal 3D printer is radiated; and a plurality of attachment portions that are provided on the base portion, have detection devices for detecting the light beam attached thereto, and are provided at mutually different positions, and the respective attachment portions being provided at mutually different angles such that detection directions of the detection devices to be attached thereto are different from each other, the built part molding method comprising:
a step of radiating the light beam to each of the detection devices attached to the calibration unit in a state in which the calibration unit is attached to the stage;
a step of acquiring a detection result of the light beam from the detection device and detecting a state of the light beam for each position on the stage on the basis of the acquired detection result of the light beam;
a step of determining whether or not the state of the light beam is normal on the basis of the state of the light beam detected in the step of detecting the state of the light beam; and
a step of controllingthe irradiation unit and the powder supply unit to mold a built part in a case where it is determinedthat the state of the light beam is normal.

18. The built part molding method according to claim 17,
wherein in the step of detecting the state of the light beam, an average output, an intensity distribution, a radiation position, and a scattered light intensity of the light beam are calculated, and
in the step of determining whether or not the state of the light beam is normal, it is determined whether or not the state of the light beam is normal on the basis of the average output, the intensity distribution, the radiation position, and the scattered light intensity of the light beam.

19. The built part molding method according to claim 18,
wherein in the step of determining whether or not the state of the light beam is normal, it is determined whether or not the state of the light beam is normal by comparing the average output, the intensity distribution, the radiation position, and the scattered light intensity of the light beam with reference data.

20. The built part molding method according to claim 18,
wherein in the step of determining whether or not the state of the light beam is normal, it is determined that the state of the light beam is normal is a case where the average output, the intensity distribution, and the radiation position of the light beam among the average output, the intensity distribution, the radiation position, and the scattered light intensity of the light beam satisfy conditions.

21. The built part molding method according to claim 17, further comprising:
a step of notifying that there is an abnormality in the irradiation unit in a case where it is determined that the state of the light beam is not normal.
